(19) United States
(12) Patent Application Publication
(10) Pub. No.: US 2009/0207391 A1
(43) Pub. Date: Aug. 20, 2009

(54) EXPOSURE APPARATUS AND DEVICE MANUFACTURING METHOD

(75) Inventor: Tatsuya Hayashi, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/369,648

(22) Filed: Feb. 11, 2009

(30) Foreign Application Priority Data
Feb. 12, 2008 (JP) 2008-030995
Dec. 18, 2008 (JP) 2008-322104

(51) Int. Cl. G03B 27/52; G03B 27/58; G03B 27/32

(52) U.S. Cl. 355/30; 355/72; 355/77

(57) ABSTRACT

An exposure apparatus 1 that includes a projection optical system 30 and that exposes the substrate 41 and 42 via immersion liquid 35 supplied between the projection optical system 30 and the substrates 41 and 42, the exposure apparatus 1 comprising substrate stages 45 and 46 which is movable independently from each other, a transfer unit 47 provided on the substrate stage 45, a transfer unit 48 provided on the substrate stage 46, and a stage controller 60 configured to move the substrate stages 41 and 42 so that the transfer units 47 and 48 pass under the immersion liquid 35 in a state where the transfer units 47 and 48 are closely positioned, wherein at least a part of a side surface of the first transfer unit and at least a part of a side surface of the second transfer unit are constituted by a porous member.

### BACKGROUND OF THE INVENTION

1. Field of the Invention

The present invention relates to an exposure apparatus, and more particularly to an immersion exposure apparatus configured to expose a substrate via liquid.

2. Description of the Related Art

In a process of manufacturing a semiconductor device configured by fine patterns such as an LSI or an ULSI, a reduced projection exposure apparatus in which a pattern formed on a mask is projected onto a wafer to which a photosensitizing agent has been applied is used. The exposure apparatus is required to further miniaturize patterns in accordance with the improvement of the integration density of semiconductor devices, and it has responded to the miniaturization in accordance with the development of resist processes.

In order to improve the resolution of the exposure apparatus, generally, it needs to shorten an exposure wavelength or enlarge numerical aperture (NA) of a projection optical system. With regard to the exposure wavelength, it is moving from i-line of 356 nm or KrF excimer laser which has an oscillation wavelength of around 248 nm to ArF excimer laser which has an oscillation wavelength of around 193 nm.

On the other hand, as an entirely different technology for improving the resolution, a projection exposure method using an immersion method is attracting attention. Conventionally, a space between an end surface (a final surface) of the projection optical system and a surface of the substrate to be exposed (for example, a wafer) was filled with gas. However, in the immersion method, this space is filled with liquid to perform a projection exposure.

The advantage of the immersion method is to be able to obtain higher resolution compared to the conventional method. For example, pure water (the refractive index is 1.33) is used as the liquid provided in the space between the projection optical system and the wafer. When a maximum incident angle of a light beam that forms an image on a wafer is assumed to be equal between the immersion method and the conventional one and a light source which has a wavelength identical to the conventional one is used, the resolution of the immersion method improves 1.33 times as much as the conventional one. This is equivalent to increasing the numerical aperture NA 1.33 times as much as the projection optical system of the conventional method. Thus, according to the immersion method, it is possible to obtain the resolution more than NA=1, which was conventionally impossible.

When the immersion method is used, the space between a final lens of the projection optical system and a wafer surface needs to be filled with liquid. It is difficult to improve throughput if the liquid filled between the edge surface of the projection optical system and the wafer surface is supplied and recovered each time wafers are exchanged. Therefore, International Publication Nos. WO 2005/074014 and WO 2006/049134 disclose a technology for exchanging wafers in a state where the space between the final lens and the wafer surface is filled with the liquid.

However, the technology disclosed in International Publication Nos. WO 2005/074014 and WO 2006/049134 may be insufficient in the following aspect.

International Publication No. WO 2005/074014 discloses a configuration where a liquid shedding is performed on the stage edge surface between the stages which transfer the immersion liquid part, and a configuration where an elastic body is sandwiched between the stages. In this case, it is difficult to prevent the liquid dripping on the stage edge surface even if the liquid leakage between the stages can be prevented. The dripped liquid will become a droplet on the stage edge surface. The dropped droplet may pollute the environment in the exposure apparatus.

International Publication No. WO 2006/049134 discloses a configuration including a recovery unit which prevents the liquid leakage between stages. The recovery unit has an effect of preventing the liquid dripping on the stage edge surface. However, the recovery unit is only provided at one stage, and the liquid dripping on the other stage edge surface cannot be prevented.

### BRIEF SUMMARY OF THE INVENTION

The present invention provides a technology which can effectively prevent the liquid leakage between stages or the liquid dripping at a stage edge part while the immersion liquid is transferred between the stages.

An exposure apparatus as one aspect of the present invention is an exposure apparatus that includes a projection optical system configured to project a pattern of an original plate onto a substrate and that exposes the substrate via liquid supplied between the projection optical system and the substrate. The exposure apparatus comprises a first substrate stage and a second substrate stage configured to support the substrate and be movable independently from each other, a first transfer unit provided on the first substrate stage and configured to transfer the liquid, a second transfer unit provided on the second substrate stage and configured to transfer the liquid, and a stage controller configured to move the first and the second substrate stages so that the first and the second transfer units pass under the liquid in a state where the first and the second transfer units are closely positioned. At least a part of a side surface of the first transfer unit and at least a part of a side surface of the second transfer unit are constituted by a porous member.

A device manufacturing method as another aspect of the present invention comprises the steps of exposing a substrate using the above exposure apparatus, and developing the exposed substrate.

Further features and aspects of the present invention will become apparent from the following description of exemplary embodiments with reference to the attached drawings.

### BRIEF DESCRIPTION OF THE DRAWINGS

FIG. 1 is a schematic configuration view of an exposure apparatus in the present embodiment.

FIG. 2 is a plan view showing a position of substrate stages in an exposure apparatus of the present embodiment.

FIG. 3 is a plan view showing a state of substrate stages when immersion liquid is transferred in an exposure apparatus of the present embodiment.

FIG. 4 is a cross-sectional configuration view around transfer units in an exposure apparatus of one of embodiments 1 to 3.

FIG. 5 is a cross-sectional configuration view around a gap formed by transfer units in an exposure apparatus of one of embodiments 2 and 3.

FIG. 6 is a cross-sectional configuration view around transfer units in an exposure apparatus of embodiment 4.

FIG. 7 is a cross-sectional configuration view around transfer units in an exposure apparatus of embodiment 5.

FIG. 8 is a plan view showing a position of substrate stages in an exposure apparatus of embodiment 7.

FIG. 9 is a plan view showing a position of substrate stages in an exposure apparatus of embodiment 7.

FIG. 10 is a plan view showing a position of substrate stages in an exposure apparatus of embodiment 7.

FIG. 11 is a cross-sectional configuration view around transfer units in an exposure apparatus of embodiment 7.

### DETAILED DESCRIPTION OF THE EMBODIMENTS

Exemplary embodiments of the present invention will be described below with reference to the accompanied drawings. In the drawings, the same elements will be denoted by the same reference numerals and the descriptions thereof will be omitted.

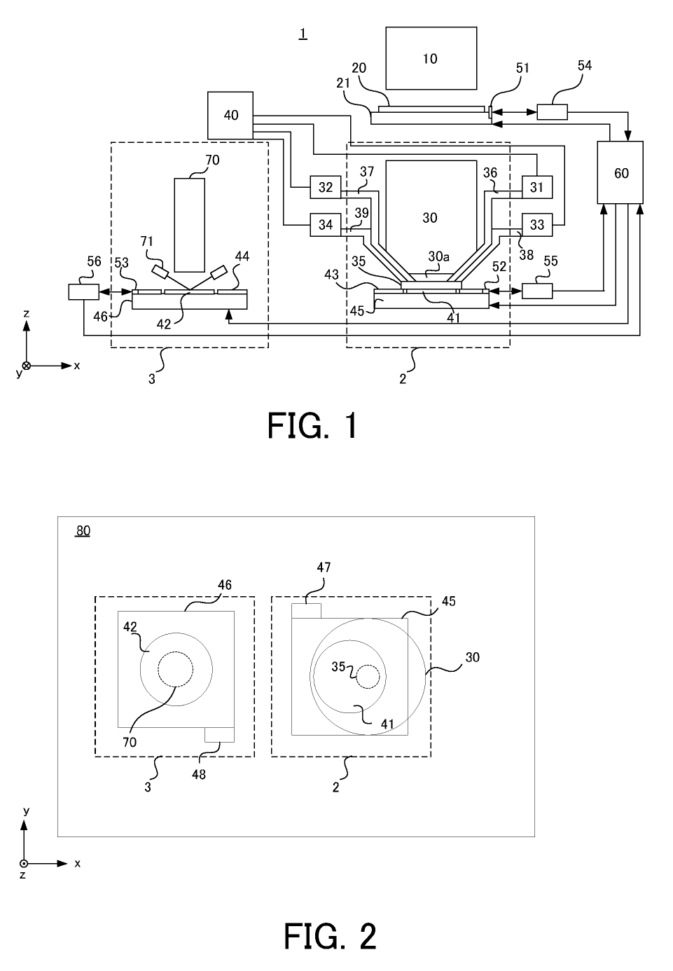

Embodiment 1 of the present invention will be described with reference to FIGS. 1 to 4.

FIG. 1 is a schematic configuration view of an exposure apparatus in the present embodiment. An exposure apparatus 1 is an immersion exposure apparatus that includes a projection optical system configured to project a pattern of an original plate (a reticle) onto a substrate (a wafer) and that exposes the substrate via liquid supplied between a final lens positioned at the substrate side of the projection optical system and the substrate.

The exposure apparatus 1 includes a reticle stage 21 which supports a reticle 20, and a substrate stage 45 (a first substrate stage) and a substrate stage 46 (a second substrate stage) which support substrates 41 and 42, respectively. The substrate stages 45 and 46 are configured to be movable independently from each other.

The inside of the exposure apparatus 1 is roughly separated into an exposure station space 2 in which an exposure is performed and a measurement station space 3 in which a measurement of a substrate is performed. The substrate stages 45 and 46 are movable between the exposure station space 2 and the measurement station space 3.

First, the exposure station space 2 will be described.

The exposure apparatus 1 includes an illumination optical system 10 which illuminates the reticle 20 and a projection optical system 30 which projects a pattern of the reticle 20 onto the substrate 41 at the exposure station space 2 side. Furthermore, the exposure apparatus 1 includes liquid supply equipments 31 and 32 which supply immersion liquid 35 (liquid) between the substrate 41 and the projection optical system 30 and liquid recovery equipments 33 and 34 which recovers the immersion liquid 35 (the liquid) supplied by the liquid supply equipments 31 and 32.

As described above, the substrate stages 45 and 46 are movable between the exposure station space 2 and the measurement station space 3. Therefore, when the substrate stage 46 is positioned in the exposure station space 2, the liquid supply equipments 31 and 32 supply the immersion liquid 35 between the projection optical system 30 and the substrate 42 which is mounted on the substrate stage 46.

Light that has emitted from a light source (not shown) such as an ArF excimer laser or an F2 laser is supplied to the illumination optical system 10. Exposure light illuminates a part of the reticle 20 (an original plate) via the illumination optical system 10.

While the reticle 20 is illuminated, the reticle stage 21 (an original plate stage) which holds the reticle 20 and the substrate stage 45 (a wafer stage) which holds the substrate 41 (the wafer) are synchronized with each other so as to perform a scanning movement. By such a synchronous scanning, overall patterns on the reticle 20 continuously form images on the substrate 41 via the projection optical system 30 and the immersion liquid 35. Thus, a photoresist (a photosensitizing agent) which has coated on a surface of the substrate 41 is exposed, and a latent image pattern can be formed.

Two-dimensional positions of the reticle stage 21 and the substrate stages 45 and 46 are measured in real time by interferometer mirrors 51, 52, and 53 and laser interferometers 54, 55, and 56. A stage controller 60 performs a positioning control and a synchronous control of the reticle stage 21 and the substrate stages 45 and 46 based on these measurement values.

The substrate stages 45 and 46 are equipped with drive units which adjust, change, or control positions in a vertical direction, rotational directions and a tilt of the substrates 41 and 42, respectively. At the time of exposure, the substrate stage 45 is controlled by the drive unit so that the exposure area on the substrate 41 always coincides with a focal plane of the projection optical system 30 with high accuracy.

Since the exposure apparatus 1 is placed in a chamber, the environment surrounding the exposure apparatus 1 is held at a desired temperature. Furthermore, air-conditioned air whose temperature is individually controlled blows into a space surrounding the reticle stage 21, the substrate stages 45 and 46, and the laser interferometers 54, 55, and 56, and a space surrounding the projection optical system 30. Thus, the temperatures in these spaces are held with higher accuracy.

The liquid supply equipments 31 and 32 supply the immersion liquid 35 (the liquid) on the substrate 41. Each of the liquid supply equipments 31 and 32 is provided with a tank which holds the immersion liquid 35, a pressure pump, and the like. The immersion liquid 35 supplied from the liquid supply equipments 31 and 32 passes through the liquid supply pipes 36 and 37 and is filled in the space between a final lens 30a and the substrate 41.

The liquid recovery equipments 33 and 34 recover the immersion liquid 35 on the substrate 41. The liquid recovery equipments 33 and 34 are provided with a suction equipment, a gas-liquid separator, a tank which holds the recovered immersion liquid, and the like. The immersion liquid 35 filled in the space between the final lens 30a and the substrate 41 passes through the liquid recovery pipes 38 and 39 and is recovered by the liquid recovery equipments 33 and 34.

A liquid supply and recovery controller 40 drives the liquid supply equipments 31 and 32 and supplies a predetermined amount of immersion liquid per unit time on the substrate 41 via the liquid supply pipes 36 and 37. Furthermore, the liquid supply and recovery controller 40 drives the liquid recovery equipments 33 and 34 and recovers a predetermined amount of immersion liquid per unit time from the substrate 41 via the liquid recovery pipes 38 and 39. The liquid supply and recovery controller 40 controls the liquid supply equipments 31 and 32 and the liquid recovery equipments 33 and 34 so that the immersion liquid 35 is always held on the substrate 41.

At an edge part of the substrate 41, in order to support the immersion liquid 35, liquid support plates 43 and 44 (plane plates) whose heights are aligned so as to be substantially the same as those of the substrates 41 and 42 are placed around the substrates 41 and 42 on the substrate stages 45 and 46.

Next, the measurement station space 3 will be described.

At the measurement station space 3 side, the exposure apparatus 1 is provided with a focus detector 71 which detects position information of the surface of the substrate 42 (position information in Z-axis direction and tilt information) and an alignment detector 70 which detects a position of the substrate 42. The focus detector 71 is provided with a projection system which projects detected light onto the surface of the substrate 42 and a light receiving system which receives reflected light from the substrate 42. The detected result (the measurement value) by the focus detector 71 is outputted to the stage controller 60.

The stage controller 60 drives the substrate stage 46 based on the detected result by the focus detector 71 and adjusts the position (the focus position) in the Z-axis direction and the angle of tilt of the substrate 42 which is held on the substrate stage 46. The detected result of the position of the substrate 42 by the alignment detector 70 is outputted to the stage controller 60 as alignment position information.

One example of a basic action of the exposure apparatus 1 which includes these two substrate stages 45 and 46 will be described as follows.

While an exposure process is performed for the substrate 41 on the substrate stage 45 in the exposure station 2, an exchange and a measurement process are performed for the substrate 42 on the substrate stage 46 in the measurement station space 3. When each process has completed, the substrate stage 45 in the exposure station space 2 moves to the measurement station space 3. In parallel, the substrate stage 46 in the measurement station space 3 moves to the exposure station space 2 and the exposure process is performed for the substrate 42.

However, in the exposure apparatus 1 of the present embodiment, the immersion liquid 35 is supplied between the substrate 41 and the final lens 30a. In order to move each of the substrate stages 45 and 46 between the exposure station space 2 and the measurement station space 3 in a state where the immersion liquid 35 is held, the immersion liquid 35 needs to be transferred between the substrate stages 45 and 46.

If the transfer is not performed between the substrate stages 45 and 46, the immersion liquid 35 needs to be recovered from the substrate 41 each time the substrate stages 45 and 46 are exchanged in the exposure station space 2 and the measurement station space 3. In this case, compared to the case where a transfer unit of the immersion liquid 35 is provided, the throughput is degraded. If the immersion liquid 35 on the substrate 41 is recovered on the substrate 41, a water spot is formed on the substrate 41 and it may cause a generation of a defect on the substrate 41.

Next, a method for transferring the immersion liquid 35 in the present embodiment will be described with reference to FIGS. 2 to 4.

FIG. 2 is a plan view showing a position of substrate stages in an exposure apparatus of the present embodiment. FIG. 2 shows a state where an exposure process is performed for the substrate 41 on the substrate stage 45 in the exposure station space 2 of an exposure apparatus (an inside 80 of the exposure apparatus). Furthermore, a measurement process is performed for the substrate 42 on the substrate stage 46 in the measurement station space 3 of the exposure apparatus (the inside 80 of the exposure apparatus).

When the exposure process in the exposure station space 2 and the measurement process in the measurement station space 3 are completed after the state shown in FIG. 2, the exchange process between the substrate stages 45 and 46 is performed. When the substrate stages 45 and 46 are exchanged, the immersion liquid 35 needs to be transferred. Therefore, the substrate stage 45 is provided with a transfer unit 47 (a first transfer unit) and the substrate stage 46 is provided with a transfer unit 48 (a second transfer unit).

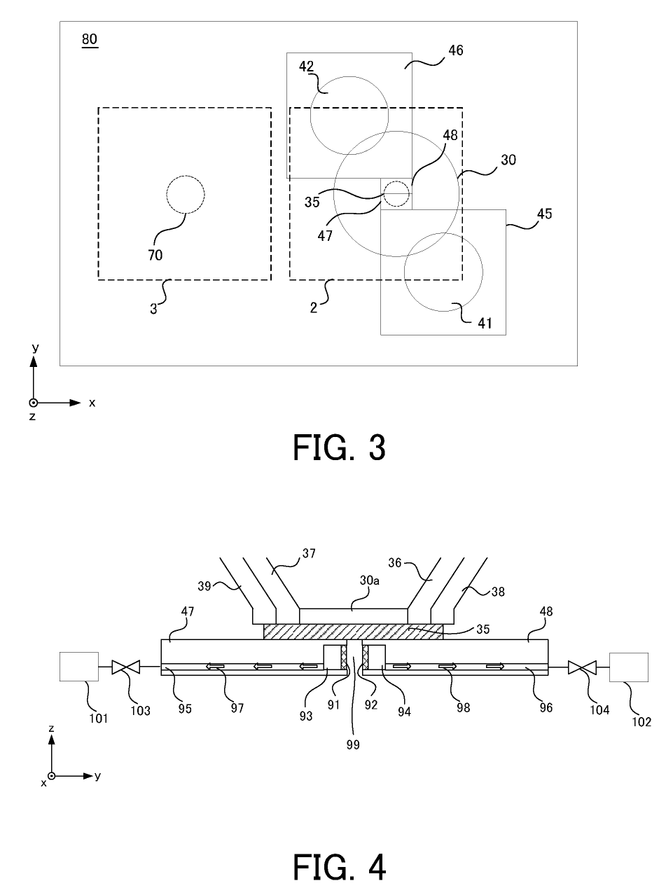

FIG. 3 shows a state where the immersion liquid 35 is being transferred. As shown in FIG. 3, the transfer unit 47 (the first transfer unit) of the substrate stage 45 and the transfer unit 48 (the second transfer unit) of the substrate stage 46 are closely positioned to each other. In this case, the transfer units 47 and 48 are positioned at the bottom of the projection optical system 30 and are positioned immediately below the immersion liquid 35.

The synchronous control of these substrate stages 45 and 46 is performed by a stage controller 60. The stage controller 60 moves the substrate stages 45 and 46 so that the transfer units 47 and 48 pass under the immersion liquid 35 in a state where they are closely positioned to each other. Thus, the immersion liquid 35 supplied from the liquid supply equipments 31 and 32 is transferred between the substrate stages 45 and 46.

Next, the configuration of the transfer units 47 and 48 in the present embodiment will be described in detail. FIG. 4 shows a cross-sectional configuration view around the transfer units in the exposure apparatus of the present embodiment.

FIG. 4 is a state where the transfer units 47 and 48 of the substrate stages 45 and 46 are closely positioned to each other, and shows a state where the immersion liquid 35 is being transferred in a +y direction. In the embodiment, the state where the transfer units 47 and 48 are closely positioned means that the transfer units 47 and 48 are closely positioned to each other to the extent that the immersion liquid 35 does not leak through a gap 99 formed by the transfer units 47 and 48.

In the present embodiment, the transfer units 47 and 48 are provided with porous members 91 and 92, respectively. The porous member 91 is provided at a side surface of the transfer unit 47 and the porous member 92 is provided at a side surface of the transfer unit 48. Thus, at least a part of a side surface of the transfer unit 47 and at least a part of a side surface of the transfer unit 48 are constituted by a porous member. The transfer units 47 and 48 are closely positioned to each other so that the porous member 91 faces the porous member 92.

In the exposure apparatus 1 of the present embodiment, the immersion liquid 35 supplied immediately below the final lens 30a may leak through the gap 99 which is formed by the transfer units 47 and 48. However, the transfer units 47 and 48 of the present embodiment are provided with porous members 91 and 92, respectively. Therefore, even if the immersion liquid 35 leaks through the gap 99, the leaked immersion liquid 35 is absorbed by the porous members 91 and 92 by a capillary force of the porous members 91 and 92.

Furthermore, for example, a droplet 110 that has dripped on the side surface 47b of the transfer unit 47 is introduced to the porous members 91 and 92 by the gravity, and is absorbed by the porous members 91 and 92 by the capillary force of the porous members 91 and 92. The transfer units can prevent the immersion liquid 35 from leaking through the gap 99, and a pollution of an exposure environment by the leakage of the immersion liquid 35 can be prevented.

It is preferable that the porous members 91 and 92 are made of a material that has lyophilic or hydrophilic properties from the viewpoint of working the capillary force. However, if the porous members 91 and 92 are not made of a material that has lyophilic properties or the porous members 91 and 92 need to enhance the lyophilic properties, a process for obtaining lyophilic properties can be performed on surfaces or parts of the inside of the porous members 91 and 92. Thus, the porous members 91 and 92 are constituted by a material that has lyophilic properties or a process for obtaining lyophilic properties is performed on the porous members 91 and 92. Therefore, a static contact angle of the porous member with respect to the immersion liquid 35 can be smaller than 90° (preferably smaller than 70°).

As the porous members 91 and 92, any member can be applicable if it has a myriad of holes and has a large surface area. For example, a member constituted by a ceramic, a sintered glass material, or a spongelike synthetic resin can be adopted.

Next, embodiment 2 of the present invention will be described. The basic configuration in the present embodiment is the same as that of embodiment 1. Therefore, the description of the present embodiment will focus on elements which are different from those of embodiment 1.

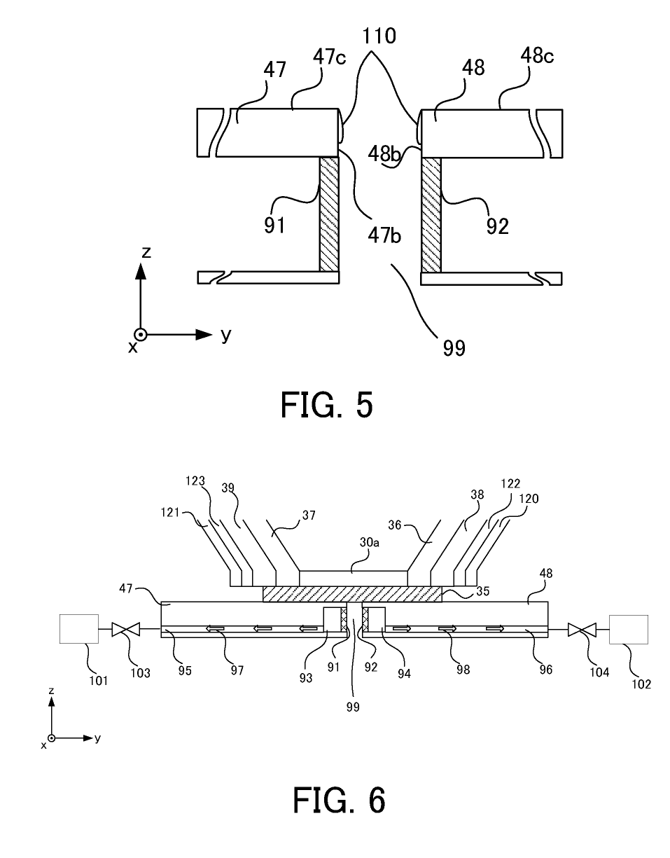

In the present embodiment, a static contact angle of upper surfaces 47c and 48c of the transfer units 47 and 48 shown in FIG. 5 with respect to the immersion liquid 35 is smaller than a static contact angle of side surfaces 47b and 48b of the transfer units 47 and 48 with respect to the immersion liquid 35. In the embodiment, the static contact angle means an angle between a plane and a liquid surface when the liquid on the plane has reached an equilibrium state. In order to meet the above relation of the static contact angle, for example, SiC (silicon carbide) or SiO2 (silicon dioxide) is used for the upper surfaces 47c and 48c of the transfer units and a fluorine series material is used for the side surfaces 47b and 48b of the transfer units.

In the present embodiment, the static contact angle between at least parts of the upper surfaces 47c and 48c of the transfer units and the immersion liquid 35 may be smaller than that between at least parts of the side surfaces 47b and 48b of the transfer units and the immersion liquid 35. At least parts of the side surfaces 47b and 48b of the transfer units are positioned at the upper side of the porous members 91 and 92.

This configuration exerts such a force that the immersion liquid 35 on the surfaces of the upper sides 47c and 48c of the transfer units expands in +y and −y directions shown in FIG. 5. Furthermore, a capillary force is exerted in the gap 99 in an upward direction (z direction). Because this force is exerted in the immersion liquid 35, the immersion liquid 35 does not easily leak through the gap 99. Even if the immersion liquid 35 drips onto the side surfaces 47b and 48b of the transfer units, the immersion liquid 35 can be effectively absorbed since the porous members 91 and 92 are provided at the lower side.

Next, embodiment 3 of the present invention will be described with reference to FIGS. 4 and 5. The basic configuration in the present embodiment is the same as that of embodiment 1. Therefore, the description of the present embodiment will focus on elements which are different from those of embodiment 1.

The porous members 91 and 92 placed on the transfer units 47 and 48 absorb immersion liquid which has leaked through the gap 99 or immersion liquid which has dripped onto the side surfaces 47b and 48b of the transfer units by the capillary force. However, eventually, the porous members 91 and 92 will be filled with these liquids and will be unable to absorb extra liquid.

Therefore, the exposure apparatus of the present embodiment is provided with spaces 93 and 94, which recover the liquid which has been absorbed by the porous members 91 and 92, adjacent to the porous members 91 and 92, recovery paths 95 and 96, suction equipments 101 and 102, and valves 103 and 104.

The spaces 93 and 94 are positioned adjacent to the porous members 91 and 92 of the transfer units 47 and 48, respectively. The recovery path 95 (a first recovery path) is connected to the space 93 which is formed in the transfer unit 47, and the recovery path 96 (a second recovery path) is connected to the space 94 which is formed in the transfer unit 48. The suction equipments 101 and 102 (suction units) suction the liquid recovered by the recovery paths 95 and 96 via the valves 103 and 104, respectively.

As shown in FIG. 4, the immersion liquid 35 absorbed in the porous members 91 and 92 is recovered in a recovery flow direction 97 and 98 by the spaces 93 and 94 positioned adjacent to the porous members 91 and 92, the recovery paths 95 and 96, and the suction equipments 101 and 102. Since the spaces 93 and 94 are placed in the transfer units 47 and 48, respectively, the immersion liquid 35 absorbed in the porous members 91 and 92 can be uniformly recovered in a plane of the porous members 91 and 92.

When the suction equipments 101 and 102 are driven in the process of moving the transfer units 47 and 48 closer to each other and transferring the immersion liquid 35 between the substrate stages 45 and 46, a negative pressure compared to around environment is exerted on the gap 99. When the negative pressure is exerted on the gap 99, in the case where the immersion liquid 35 is transferred between the substrate stages 45 and 46, the immersion liquid 35 gets sucked into the gap 99 by the pressure difference and an amount of the liquid which leaks into the gap increases.

In order to avoid this, the recovery of the immersion liquid 35 which has been absorbed by the porous members 91 and 92 is controlled so as to be performed before and/or after the immersion liquid 35 is transferred between the substrate stages 45 and 46. The “before and after” indicates “before and after the immersion liquid 35 passes through the gap 99” and it is a state where the immersion liquid 35 does not exist over the gap 99.

Thus, the suction equipments 101 and 102 (the suction units) of the present embodiment suctions the immersion liquid 35 before and/or after the immersion liquid 35 is transferred between the transfer units 47 and 48. Therefore, according to the present embodiment, the immersion liquid 35 can be reliably transferred between the substrate stages 45 and 46, and the immersion liquid 35 absorbed in the porous members 91 and 92 can be effectively recovered.

Embodiment 4 of the present invention will be described with reference to FIG. 6. The basic configuration in the present embodiment is the same as that of embodiment 1. Therefore, the description of the present embodiment will focus on elements which are different from those of embodiment 1.

FIG. 6 shows a cross-sectional configuration around transfer units in an exposure apparatus of embodiment 4. As shown in FIG. 6, the exposure apparatus of the present embodiment is provided with gas supply ports 120 and 121 (gas supply units) which supply gas to the outside of the immersion liquid 35 supplied from the liquid supply equipments 31 and 32. Furthermore, the exposure apparatus is provided with gas recovery ports 122 and 123 which recover at least a part of the supplied gas.

The gas supply ports 120 and 121 and the gas recovery ports 122 and 123 are provided for preventing the immersion liquid 35 from splashing in the exposure apparatus. The gas supply ports 120 and 121 and the gas recovery ports 122 and 123 are positioned at the outside of the liquid supply pipes 36 and 37 and the liquid recovery pipes 38 and 39 in order that the immersion liquid 35 supplied immediately below the projection optical system 30 leaks out of its surroundings.

As in the case of the present embodiment, when the exposure apparatus which supplies the gas around the immersion liquid 35 transfers the immersion liquid 35 between the transfer units 47 and 48, a part of the gas supplied from the gas supply ports 120 and 121 possibly flows into the gap 99.

The gas flowing into the gap 99 involves the immersion liquid 35 and causes the leakage of the immersion liquid 35 through the gap 99. Therefore, when the gas supply ports 120 and 121 (gas supply units) of the present embodiment transfers the immersion liquid 35 between the transfer units 47 and 48, it stops supplying the gas. In other words, the immersion liquid 35 is transferred in a state where the exposure apparatus stops supplying the gas from the gas supply ports 120 and 121.

This control can prevent the immersion liquid 35 from leaking through the gap 99 at the time of transferring the immersion liquid 35.

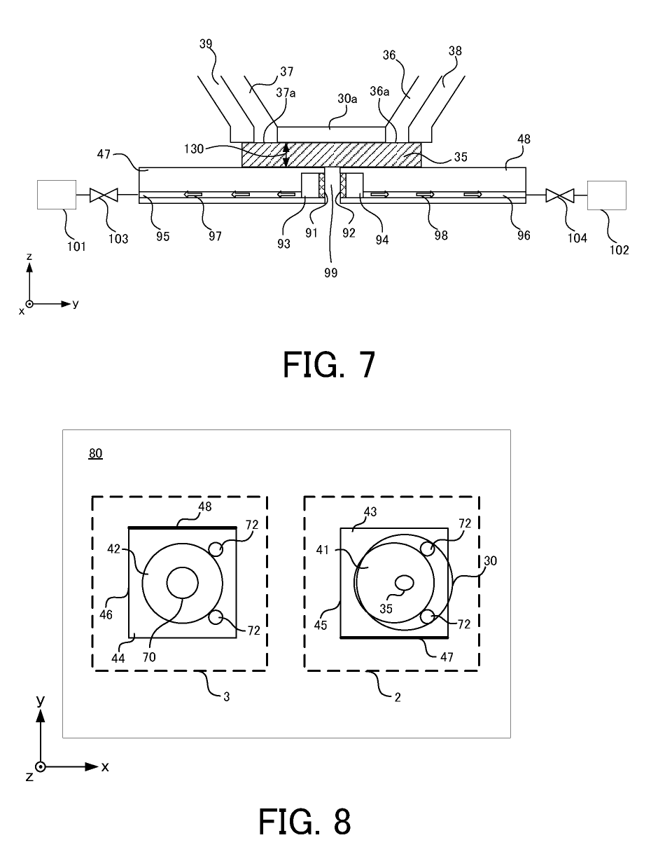

Embodiment 5 of the present invention will be described with reference to FIG. 7. The basic configuration in the present embodiment is the same as that of embodiment 1. Therefore, the description of the present embodiment will focus on elements which are different from those of embodiment 1.

FIG. 7 is a cross-sectional configuration view around transfer units in an exposure apparatus of embodiment 5. The immersion liquid 35 supplied from liquid supply ports 36a and 37a are supplied with a velocity component in a downward direction (−z direction). However, in the exposure apparatus of the present embodiment, the liquid supply ports 36a and 37a are disposed so as to face the downward direction (−z direction), it is not limited to this. For example, the liquid supply ports 36a and 37a may be disposed so as to face a lateral direction.

When the liquid supply ports 36a and 37a are disposed in the downward direction (−z direction) or a velocity component of the downward direction (−z direction) is formed at the inside of the immersion liquid 35, the immersion liquid 35 easily leaks through the gap 99 at the time of transferring the immersion liquid 35. Therefore, in the present embodiment, when the immersion liquid 35 is transferred at the transfer units 47 and 48, the transfer is performed in a state where a gap height 130 between the final lens 30a and the transfer units 47 and 48 is held so as to be higher than a height (z direction) between the final lens 30a and the substrate 41 at the time of exposure.

The gap height 130 between the final lens 30a and the transfer units 47 and 48 can be adjusted by the stage controller 60 which controls the height (z direction) of the substrate stages 45 and 46. Thus, when the immersion liquid 35 is transferred between the transfer units 47 and 48, the stage controller 60 controls a distance between the projection optical system 30 and the transfer units 47 and 48 is greater than that between the projection optical system 30 and the substrates 41 and 42 at the time of exposure.

The control by the stage controller 60 eases the velocity component in a downward direction (−z direction) at the inside of the immersion liquid 35 and can prevent the immersion liquid 35 from leaking through the gap 99.

Next, embodiment 6 of the present invention will be described. The basic configuration in the present embodiment is the same as that of embodiment 1. Therefore, the description of the present embodiment will focus on elements which are different from those of embodiment 1.

In embodiment 4, a method for transferring the immersion liquid 35 in a state where the gas supply from the gas supply ports 120 and 121 stops when the immersion liquid 35 is transferred between the transfer units 47 and 48 was described. The method of embodiment 4 is effective in order to prevent the liquid leakage through the gap 99. However, the moving velocity of the substrate stages 45 and 46 needs to be slow down to the extent that the immersion liquid 35 is not splashed. In this case, the reduction of throughput cannot be avoided.

In the present embodiment, in order to prevent the reduction of throughput for the reason above, a method for transferring the immersion liquid 35 in the case where the gas is continuously supplied from the gas supply ports 120 and 121 will be described.

Embodiment 4 described the leakage of the immersion liquid 35 through the gap 99 when the gas is continuously supplied from the gas supply ports 120 and 121 in transferring the immersion liquid 35 between the transfer units 47 and 48. Therefore, the immersion liquid 35 which has leaked through the gap 99 needs to be recovered. Recovering the immersion liquid 35 is performed by the porous members 91 and 92 which are placed at the transfer units 47 and 48, respectively, as shown in FIG. 6.

However, in the present embodiment, in accordance with the amount of the immersion liquid 35 which has leaked through the gap 99, the porous members 91 and 92 may not be able to completely recover the liquid by its capillary force. In this case, the amount of the recovery by the porous members 91 and 92 needs to be increased by driving the suction equipments 101 and 102 and by negatively pressuring the recovering spaces 93 and 94.

In this case, the gap 99 is also negatively pressured, and the immersion liquid 35 or the gas easily flows into it. Therefore, although the increase of the recovery amount of the gas and the immersion liquid to be recovered cannot be avoided, the moving velocity of the substrate stages 45 and 46 does not have to be reduced at the time of the transfer.

Next, embodiment 7 of the present invention will be described. The basic configuration in the present embodiment is the same as that of embodiment 1. Therefore, the description of the present embodiment will focus on elements which are different from those of embodiment 1.

The shape of the transfer units 47 and 48 shown in FIG. 2 is configured not to block the interferometer mirrors 52 and 53 used for measuring the position of the substrate stages 45 and 46 shown in FIG. 1 and not to block optical axes of the laser interferometers 55 and 56. In other words, in accordance with the configuration of the position measuring system, the shape of the transfer units 47 and 48 is not limited to the shape shown in any one of embodiments 1 to 6.

The present embodiment will describe the case where the transfer units 47 and 48 do not have the shape shown in FIG. 2 but are configured by parts of the liquid support plates 43 and 44 shown in FIG. 8 and side surfaces of the substrate stages 45 and 46.

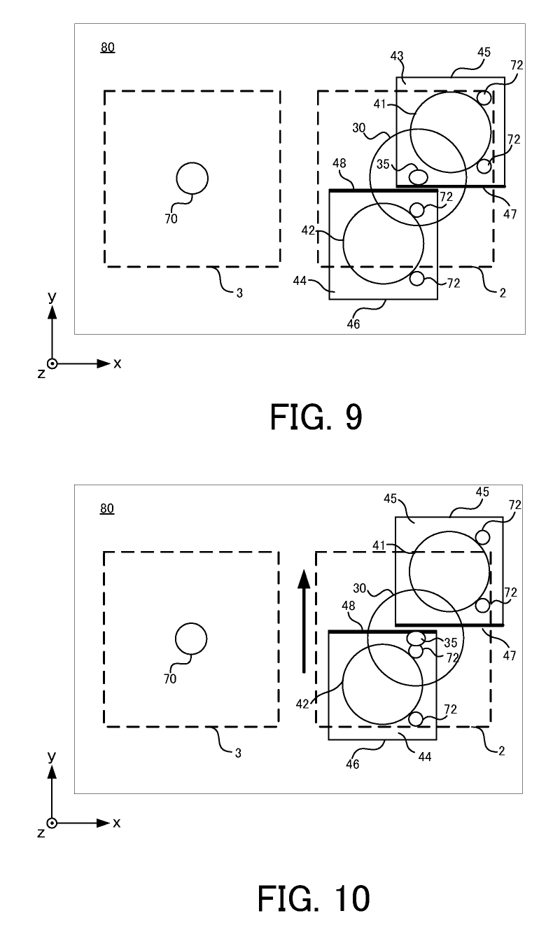

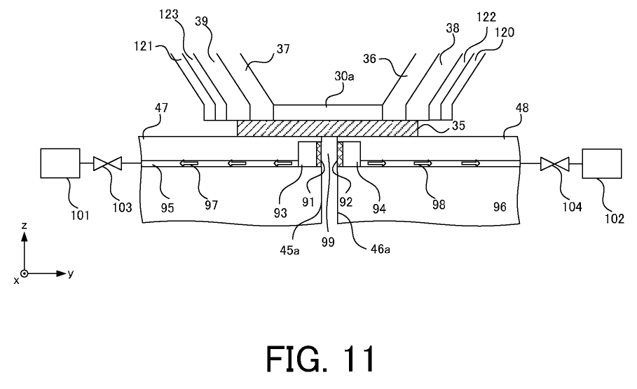

FIG. 8 shows the situation where the substrate 41 is exposed in the exposure station space 2, and in parallel, the substrate 42 is measured in the measurement station space 3. When the exposure and the measurement are completed, in order to exchange the substrates, the substrates 45 and 46 are closely positioned as shown in FIG. 9. Also, as shown in FIG. 11, the porous members 91 and 92 are positioned on substrate stage side surfaces 45a and 46a which constitute the transfer units 47 and 48, respectively. Furthermore, a recovery mechanism which recovers the immersion liquid 35 which has leaked through the gap 99 formed by the porous members 91 and 92 with the capillary force of the porous members 91 and 92 is provided.

In order to recover the immersion liquid 35 accumulated in the porous members 91 and 92, the spaces 93 and 94 placed adjacent to the porous members 91 and 92, the recovery paths 95 and 96, and the suction equipments 101 and 102 are provided. The immersion liquid 35 accumulated in the porous members 91 and 92 is recovered by the suction equipments 101 and 102 along flow directions 97 and 98.

The immersion liquid absorbed in the porous members 91 and 92 can be uniformly recovered in the planes of the porous members 91 and 92 by placing the spaces 93 and 94. When the leaked immersion liquid cannot be completely recovered by the capillary force of the porous members 91 and 92 cannot be completely recovered at the time of transferring the immersion liquid 35, as described in embodiment 6, the recovery may be performed by driving the suction equipments 101 and 102.

The porous members 91 and 92 may be a ceramic, a sintered glass material, or a spongelike member constituted by a synthetic resin. It is preferable that the surfaces of the porous members 91 and 92 have hydrophilic properties (the static contact angle is smaller than 90°).

The substrate stages 45 and 46 move in a direction indicated by the arrow in FIG. 10 from the state shown in FIG. 9, and the immersion liquid 35 is transferred from the substrate 45 to the substrate 46.

In the present embodiment, since the transfer units 47 and 48 constitute one side of the substrate stages 45 and 46, respectively, there is flexibility for the position where the immersion liquid 35 is transferred, compared to any one of embodiments 1 to 6. Therefore, the immersion liquid 35 can be also transferred at the positions of the substrate stages 45 and 46 as shown in FIG. 10.

When the immersion liquid 35 is transferred at the position relation of the substrate stages 45 and 46, the distance between the transfer position and a reference mark 72 on the substrate stage 46 can be shortened. The process of measuring the reference mark 72 is necessary for aligning a position relation between the reticle 20 and the substrate stage 46, and has to be completed before the exposure is performed. Thus, if the distance between the transfer position of the immersion liquid 35 and the reference mark 72 can be shortened, the moving time of the substrate stage 46 can be shortened and the throughput can be improved.

Although the present embodiment described the case where the transfer units 47 and 48 are provided continuously along the side surfaces of the substrate stages 45 and 46, they may be partially provided.

Furthermore, the present embodiment described the case where the porous members 91 and 92 positioned on the substrate stage side surfaces 45a and 46a are positioned continuously along the substrate stage side surfaces 45a and 46a. However, the porous members 91 and 92 may be partially positioned along the substrate stage side surfaces 45a and 46a.

A device (a semiconductor integrated circuit device, a liquid crystal display device, or the like) is manufactured by a step of exposing a substrate (a wafer, a glass plate, or the like) coated by a photosensitizing agent using the exposure apparatus of one of the above embodiments, a step of developing the substrate, and other well-known steps.

According to the device manufacturing method, devices with higher quality, compared to conventional one, can be manufactured. Thus, the device manufacturing method using the exposure apparatus 1 and the device as a result object also constitute one aspect of the present invention.

According to each of the above embodiments, an exposure apparatus that effectively prevents the pollution caused by the liquid leakage or the liquid dripping can be provided. In other words, an exposure apparatus that effectively prevents the environmental pollution in the exposure apparatus caused by the liquid leakage between stages or the liquid dripping at the stage edge surfaces and that suppresses the reduction of the exposure accuracy or the measurement accuracy as much as possible can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-030995, filed on Feb. 12, 2008, and Japanese Patent Application No. 2008-322104, filed on Dec. 18, 2008, which are hereby incorporated by reference herein in their entirety.

What is claimed is:

1. An exposure apparatus that includes a projection optical system configured to project a pattern of an original plate onto a substrate and that exposes the substrate via liquid supplied between the projection optical system and the substrate, the exposure apparatus comprising:
a first substrate stage and a second substrate stage configured to support the substrate and be movable independently from each other;
a first transfer unit provided on the first substrate stage and configured to transfer the liquid;
a second transfer unit provided on the second substrate stage and configured to transfer the liquid; and
a stage controller configured to move the first and the second substrate stages so that the first and the second transfer units pass under the liquid in a state where the first and the second transfer units are closely positioned,
wherein at least a part of a side surface of the first transfer unit and at least a part of a side surface of the second transfer unit are constituted by a porous member.

2. An exposure apparatus according to claim 1,
wherein at least a part of the porous member is made of a lyophilic material.

3. An exposure apparatus according to claim 1,
wherein a static contact angle between at least a part of an upper surface of one of the first and the second transfer units and the liquid is smaller than that between at least a part of an side surface of one of the first and the second transfer units and the liquid, and
wherein at least the part of the side surface is positioned at an upper side of the porous member.

4. An exposure apparatus according to claim 1, further comprising a suction unit configured to suction the liquid,
wherein the first transfer unit is provided with a first recovery path for recovering the liquid absorbed by the porous member,
wherein the second transfer unit is provided with a second recovery path for recovering the liquid absorbed by the porous member, and
wherein the suction unit suctions the liquid recovered through the first and the second recovery paths.

5. An exposure apparatus according to claim 4,
wherein the suction unit suctions the liquid before or after transferring the liquid between the first and the second transfer units.

6. An exposure apparatus according to claim 1, further comprising a gas supply unit configured to supply gas to an outside of the liquid,
wherein the gas supply unit stops supplying the gas when the liquid is transferred between the first and the second transfer units.

7. An exposure apparatus according to claim 1,
wherein when the liquid is transferred between the first and the second transfer units, the stage controller performs control so that a distance between the projection optical system and the first and the second transfer units is greater than that between the projection optical system and the substrate at the time of exposure.

8. A device manufacturing method comprising the steps of:
exposing a substrate using an exposure apparatus; and
developing the exposed substrate,
wherein the exposure apparatus includes a projection optical system configured to project a pattern of an original plate onto a substrate and exposes the substrate via liquid supplied between the projection optical system and the substrate, the exposure apparatus comprising:
a first substrate stage and a second substrate stage configured to support the substrate and be movable independently from each other;
a first transfer unit provided on the first substrate stage and configured to transfer the liquid;
a second transfer unit provided on the second substrate stage and configured to transfer the liquid; and
a stage controller configured to move the first and the second substrate stages so that the first and the second transfer units pass under the liquid in a state where the first and the second transfer units are closely positioned, and
wherein at least a part of a side surface of the first transfer units and at least a part of a side surface of the second transfer unit are constituted by a porous member.
